(19) United States
(12) Patent Application Publication
(10) Pub. No.: US 2022/0036819 A1
(43) Pub. Date: Feb. 3, 2022

(54) ORGANIC LIGHT-EMITTING DIODE DISPLAY DEVICE AND OPERATING METHOD THEREOF

(71) Applicant: LG ELECTRONICS INC., Seoul (KR)

(72) Inventor: Heechen KANG, Seoul (KR)

(73) Assignee: LG ELECTRONICS INC., Seoul (KR)

(21) Appl. No.: 17/033,570

(22) Filed: Sep. 25, 2020

(30) Foreign Application Priority Data
Jul. 28, 2020 (KR) 10-2020-0093466

(51) Int. Cl. G09G 3/3233; G09G 5/10

(52) U.S. Cl. CPC G09G 3/3233; G09G 2320/0646; G09G 2330/023; G09G 5/10

(57) ABSTRACT

An organic light-emitting diode display device include a display panel, and a processor configured to acquire average brightness of an image frame input to the display panel, determine a luminance maintaining region corresponding to a range, to which the acquired average brightness belongs, in an entire region of a screen of the display panel, and perform a convex power control (CPC) algorithm according to the determined luminance maintaining region.

### CROSS-REFERENCE TO RELATED APPLICATIONS

Pursuant to 35 U.S.C. § 119(a), this application claims the benefit of earlier filing date and right of priority to Korean Patent Application No. 10-2020-0093466, filed on Jul. 28, 2020, the contents of which are hereby incorporated by reference herein in its entirety.

### BACKGROUND

The present disclosure relates to a display device, and more particularly, to an organic light emitting diode display device.

Recently, various types of display devices have been provided. Among them, an Organic Light Emitting Diode display device (hereinafter referred to as “OLED display device”) is frequently used.

The OLED display device is a display device using organic light emitting elements. Since the organic light emitting elements are self-light-emitting elements, the OLED display device has advantages of being fabricated to have lower power consumption and be thinner than a liquid crystal display device requiring a backlight. In addition, the OLED display device has advantages such as a wide viewing angle and a fast response speed.

In an OLED display device, technology for reducing power consumption is very important. As the technology for reducing power consumption, there is a convex power control (CPC) algorithm. The CPC algorithm refers to an algorithm for reducing power consumption of a display device by reducing the luminance of an outer region of a screen, to which a user does not pay attention.

The CPC algorithm refers to an algorithm for reducing power consumption of a display device by reducing the luminance of an outer region while maintaining the luminance of a central region, on the assumption that a region, to which a user pays attention, is the central region of the screen and a region, to which the user does not pay attention, is the outer region of the screen.

Since the number of pixels of an OLED display device having resolution of 8K (7680×4320) is greater than that of an OLED display having resolution of 4K (3840×2160), the 8K OLED display device is slightly more vulnerable to afterimages and has higher power consumption.

The 8K OLED display device, to which a CPC algorithm having a fixed ratio is applied, is more vulnerable to after images and has higher power consumption, as compared to the 4K OLED display device.

### SUMMARY

The present disclosure is devised to solve the above-described problems and an object of the present disclosure is to reduce afterimages and power consumption of an OLED display device, by flexibly adjusting a ratio of a region, to which convex power control (CPC) is applied, to a screen.

The present disclosure is to reduce afterimages and power consumption of an OLED display device, by changing an application ratio of a CPC algorithm according to the average brightness of an image frame.

### BRIEF DESCRIPTION OF THE DRAWINGS

FIG. 1 is a diagram illustrating a display device according to an embodiment of the present disclosure.

FIG. 2 is a block diagram showing a configuration of the display device of FIG. 1.

FIG. 3 is an example of an internal block diagram of the control unit of FIG. 2.

FIG. 4A is a diagram illustrating a control method for a remote control device of FIG. 2.

FIG. 4B is an internal block diagram of the remote control device of FIG. 2.

FIG. 5 is an internal block diagram of the display unit of FIG. 2.

FIGS. 6A to 6B are views referred to for description of the organic light emitting panel of FIG. 5.

FIG. 7 is a flowchart illustrating a method of operating a display device according to an embodiment of the present disclosure.

FIGS. 8 and 9 are views illustrating a CPC algorithm according to an embodiment of the present disclosure.

FIG. 10 is a view illustrating a CPC algorithm driving method when the average brightness of an image frame is in a first range, according to an embodiment of the present disclosure.

FIG. 11 is a view illustrating a CPC algorithm driving method when the average brightness of an image frame is in a second range, according to an embodiment of the present disclosure.

FIG. 12 is a view illustrating a CPC algorithm driving method when the average brightness of an image frame is in a third range, according to an embodiment of the present disclosure.

FIG. 13 is a flowchart illustrating a method of operating a display device according to another embodiment of the present disclosure.

FIGS. 14 and 15 are views showing a process of determining a luminance maintaining region according to a range, to which an average brightness belongs, when a scene change occurs, according to an embodiment of the present disclosure.

FIG. 16 is a table showing the effect of reducing actual power consumption when the embodiment of the present disclosure is applied.

### DETAILED DESCRIPTION OF THE EMBODIMENTS

Hereinafter, the present disclosure will be described in more detail with reference to the drawings.

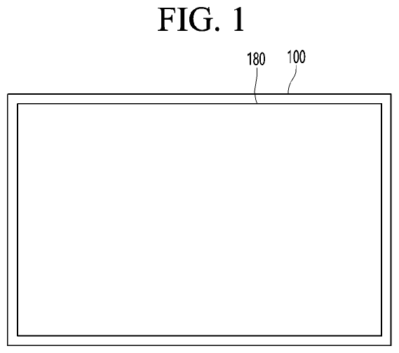

FIG. 1 is a diagram illustrating a display device according to an embodiment of the present disclosure.

Referring to the drawings, a display device 100 may include a display unit 180.

Meanwhile, the display unit 180 may be implemented with any one of various panels. For example, the display unit 180 may be any one of a liquid crystal display panel (LCD panel), an organic light emitting diode panel (OLED panel), and an inorganic light emitting diode panel (LED panel).

In the present disclosure, it is assumed that the display unit 180 includes an organic light emitting diode panel (OLED panel). It should be noted that this is only exemplary, and the display unit 180 may include a panel other than an organic light emitting diode panel (OLED panel).

Meanwhile, the display device 100 of FIG. 1 may be a monitor, a TV, a tablet PC, or a mobile terminal.

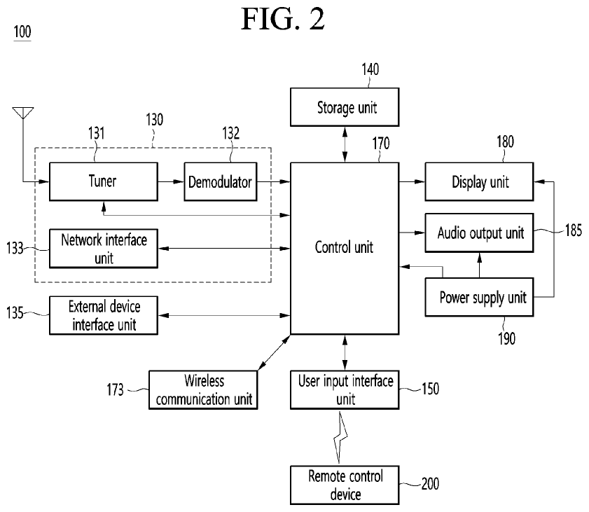

FIG. 2 is a block diagram showing a configuration of the display device of FIG. 1.

Referring to FIG. 2, the display device 100 may include a broadcast receiving unit 130, an external device interface unit 135, a storage unit 140, a user input interface unit 150, a control unit 170, and a wireless communication unit 173, a display unit 180, an audio output unit 185, and a power supply unit 190.

The broadcast receiving unit 130 may include a tuner 131, a demodulator 132, and a network interface unit 133.

The tuner 131 may select a specific broadcast channel according to a channel selection command. The tuner 131 may receive a broadcast signal for the selected specific broadcast channel.

The demodulator 132 may separate the received broadcast signal into a video signal, an audio signal, and a data signal related to a broadcast program, and restore the separated video signal, audio signal, and data signal to a format capable of being output.

The network interface unit 133 may provide an interface for connecting the display device 100 to a wired/wireless network including an Internet network. The network interface unit 133 may transmit or receive data to or from other users or other electronic devices through a connected network or another network linked to the connected network.

The network interface unit 133 may access a predetermined web page through the connected network or the other network linked to the connected network. That is, it is possible to access a predetermined web page through a network, and transmit or receive data to or from a corresponding server.

In addition, the network interface unit 133 may receive content or data provided by a content provider or a network operator. That is, the network interface unit 133 may receive content such as a movie, advertisement, game, VOD, broadcast signal, and related information provided by a content provider or a network provider through a network.

In addition, the network interface unit 133 may receive update information and update files of firmware provided by the network operator, and may transmit data to an Internet or content provider or a network operator.

The network interface unit 133 may select and receive a desired application from among applications that are open to the public through a network.

The external device interface unit 135 may receive an application or a list of applications in an external device adjacent thereto, and transmit the same to the control unit 170 or the storage unit 140.

The external device interface unit 135 may provide a connection path between the display device 100 and the external device. The external device interface unit 135 may receive one or more of video and audio output from an external device wirelessly or wired to the display device 100 and transmit the same to the control unit 170. The external device interface unit 135 may include a plurality of external input terminals. The plurality of external input terminals may include an RGB terminal, one or more High Definition Multimedia Interface (HDMI) terminals, and a component terminal.

The video signal of the external device input through the external device interface unit 135 may be output through the display unit 180. The audio signal of the external device input through the external device interface unit 135 may be output through the audio output unit 185.

The external device connectable to the external device interface unit 135 may be any one of a set-top box, a Blu-ray player, a DVD player, a game machine, a sound bar, a smartphone, a PC, a USB memory, and a home theater, but this is only an example.

In addition, a part of content data stored in the display device 100 may be transmitted to a selected user among a selected user or a selected electronic device among other users or other electronic devices registered in advance in the display device 100.

The storage unit 140 may store programs for signal processing and control of the control unit 170, and may store video, audio, or data signals, which have been subjected to signal-processed.

In addition, the storage unit 140 may perform a function for temporarily storing video, audio, or data signals input from an external device interface unit 135 or the network interface unit 133, and store information on a predetermined video through a channel storage function.

The storage unit 140 may store an application or a list of applications input from the external device interface unit 135 or the network interface unit 133.

The display device 100 may play back a content file (a moving image file, a still image file, a music file, a document file, an application file, or the like) stored in the storage unit 140 and provide the same to the user.

The user input interface unit 150 may transmit a signal input by the user to the control unit 170 or a signal from the control unit 170 to the user. For example, the user input interface unit 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the control unit 170 to the remote control device 200.

In addition, the user input interface unit 150 may transmit a control signal input from a local key (not shown) such as a power key, a channel key, a volume key, and a setting value to the control unit 170.

The video signal image-processed by the control unit 170 may be input to the display unit 180 and displayed with video corresponding to a corresponding video signal. Also, the video signal image-processed by the control unit 170 may be input to an external output device through the external device interface unit 135.

The audio signal processed by the control unit 170 may be output to the audio output unit 185. Also, the audio signal processed by the control unit 170 may be input to the external output device through the external device interface unit 135.

In addition, the control unit 170 may control the overall operation of the display device 100.

In addition, the control unit 170 may control the display device 100 by a user command input through the user input interface unit 150 or an internal program and connect to a network to download an application a list of applications or applications desired by the user to the display device 100.

The control unit 170 may allow the channel information or the like selected by the user to be output through the display unit 180 or the audio output unit 185 along with the processed video or audio signal.

In addition, the control unit 170 may output a video signal or an audio signal through the display unit 180 or the audio output unit 185, according to a command for playing back a video of an external device through the user input interface unit 150, the video signal or the audio signal being input from an external device, for example, a camera or a camcorder, through the external device interface unit 135.

Meanwhile, the control unit 170 may allow the display unit 180 to display a video, for example, allow a broadcast video which is input through the tuner 131 or an external input video which is input through the external device interface unit 135, a video which is input through the network interface unit or a video which is stored in the storage unit 140 to be displayed on the display unit 180. In this case, the video displayed on the display unit 180 may be a still image or a moving image, and may be a 2D image or a 3D image.

In addition, the control unit 170 may allow content stored in the display device 100, received broadcast content, or external input content input from the outside to be played back, and the content may have various forms such as a broadcast video, an external input video, an audio file, still images, accessed web screens, and document files.

The wireless communication unit 173 may communicate with an external device through wired or wireless communication. The wireless communication unit 173 may perform short range communication with an external device. To this end, the wireless communication unit 173 may support short range communication using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication unit 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication unit 173 may detect (or recognize) a wearable device capable of communication around the display device 100. Furthermore, when the detected wearable device is an authenticated device to communicate with the display device 100 according to the present disclosure, the control unit 170 may transmit at least a portion of data processed by the display device 100 to the wearable device through the wireless communication unit 173. Therefore, a user of the wearable device may use data processed by the display device 100 through the wearable device.

The display unit 180 may convert a video signals, data signal, or OSD signal processed by the control unit 170, or a video signal or data signal received from the external device interface unit 135 into R, G, and B signals, and generate drive signals.

Meanwhile, the display device 100 illustrated in FIG. 2 is only an embodiment of the present disclosure, and therefore, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 2, the display device 100 may receive a video through the network interface unit 133 or the external device interface unit 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 2 and but also one of an image processing device such as the separated set-top box and a content playback device including the display unit 180 the audio output unit 185.

The audio output unit 185 may receive a signal audio-processed by the control unit 170 and output the same with audio.

The power supply unit 190 may supply corresponding power to the display device 100. Particularly, power may be supplied to the control unit 170 that may be implemented in the form of a system on chip (SOC), the display unit 180 for video display, and the audio output unit 185 for audio output.

Specifically, the power supply unit 190 may include a converter that converts AC power into DC power, and a dc/dc converter that converts a level of DC power.

The remote control device 200 may transmit a user input to the user input interface unit 150. To this end, the remote control device 200 may use Bluetooth, Radio Frequency (RF) communication, Infrared (IR) communication, Ultra Wideband (UWB), ZigBee, or the like. In addition, the remote control device 200 may receive a video, audio, or data signal or the like output from the user input interface unit 150, and display or output the same through the remote control device 200 by video or audio.

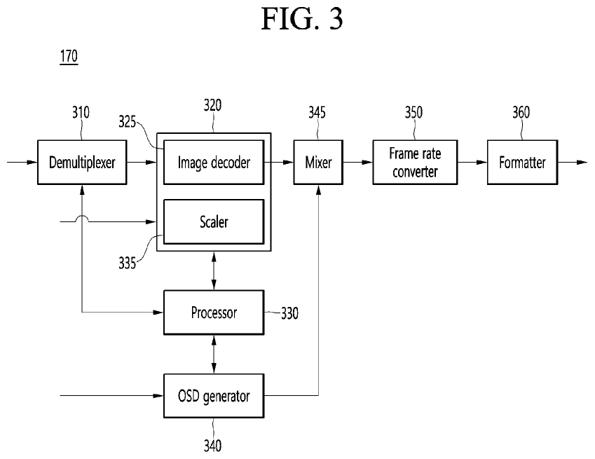

FIG. 3 is an example of an internal block diagram of the controller of FIG. 2.

Referring to the drawings, the control unit 170 according to an embodiment of the present disclosure may include a demultiplexer 310, an image processing unit 320, a processor 330, an OSD generator 340, a mixer 345, a frame rate converter 350, and a formatter 360. In addition, an audio processing unit (not shown) and a data processing unit (not shown) may be further included.

The demultiplexer 310 may demultiplex input stream. For example, when MPEG-2 TS is input, the demultiplexer 310 may demultiplex the MPEG-2 TS to separate the MPEG-2 TS into video, audio, and data signals. Here, the stream signal input to the demultiplexer 310 may be a stream signal output from the tuner 131, the demodulator 132 or the external device interface unit 135.

The image processing unit 320 may perform image processing on the demultiplexed video signal. To this end, the image processing unit 320 may include an image decoder 325 and a scaler 335.

The image decoder 325 may decode the demultiplexed video signal, and the scaler 335 may scale a resolution of the decoded video signal to be output through the display unit 180.

The video decoder 325 may be provided with decoders of various standards. For example, an MPEG-2, H.264 decoder, a 3D video decoder for color images and depth images, and a decoder for multi-view images may be provided.

The processor 330 may control the overall operation of the display device 100 or of the control unit 170. For example, the processor 330 may control the tuner 131 to select (tune) an RF broadcast corresponding to a channel selected by a user or a pre-stored channel.

In addition, the processor 330 may control the display device 100 by a user command input through the user input interface unit 150 or an internal program.

In addition, the processor 330 may perform data transmission control with the network interface unit 135 or the external device interface unit 135.

In addition, the processor 330 may control operations of the demultiplexer 310, the image processing unit 320, and the OSD generator 340 in the control unit 170.

The OSD generator 340 may generate an OSD signal according to a user input or by itself. For example, based on a user input signal, a signal for displaying various information on a screen of the display unit 180 as a graphic or text may be generated. The generated OSD signal may include various data such as a user interface screen, various menu screens, widgets, and icons of the display device 100. In addition, the generated OSD signal may include a 2D object or a 3D object.

In addition, the OSD generator 340 may generate a pointer that may be displayed on the display unit 180 based on a pointing signal input from the remote control device 200. In particular, such a pointer may be generated by the pointing signal processing unit, and the OSD generator 340 may include such a pointing signal processing unit (not shown). Of course, the pointing signal processing unit (not shown) may be provided separately, not be provided in the OSD generator 340

The mixer 345 may mix the OSD signal generated by the OSD generator 340 and the decoded video signal image-processed by the image processing unit 320. The mixed video signal may be provided to the frame rate converter 350.

The frame rate converter (FRC) 350 may convert a frame rate of an input video. On the other hand, the frame rate converter 350 may output the input video as it is, without a separate frame rate conversion.

On the other hand, the formatter 360 may change the format of the input video signal into a video signal to be displayed on the display and output the same.

The formatter 360 may change the format of the video signal. For example, it is possible to change the format of the 3D video signal to any one of various 3D formats such as a side by side format, a top/down format, a frame sequential format, an interlaced format, a checker box and the like.

Meanwhile, the audio processing unit (not shown) in the control unit 170 may perform audio processing of a demultiplexed audio signal. To this end, the audio processing unit (not shown) may include various decoders.

In addition, the audio processing unit (not shown) in the control unit 170 may process a base, treble, volume control, and the like.

The data processing unit (not shown) in the control unit 170 may perform data processing of the demultiplexed data signal. For example, when the demultiplexed data signal is an encoded data signal, the demultiplexed data signal may be decoded. The coded data signal may be electronic program guide information including broadcast information such as a start time and an end time of a broadcast program broadcast on each channel.

Meanwhile, a block diagram of the control unit 170 illustrated in FIG. 3 is a block diagram for an embodiment of the present disclosure. The components of the block diagram may be integrated, added, or omitted depending on the specification of the control unit 170 that is actually implemented.

In particular, the frame rate converter 350 and the formatter 360 may not be provided in the control unit 170, and may be separately provided or separately provided as a single module.

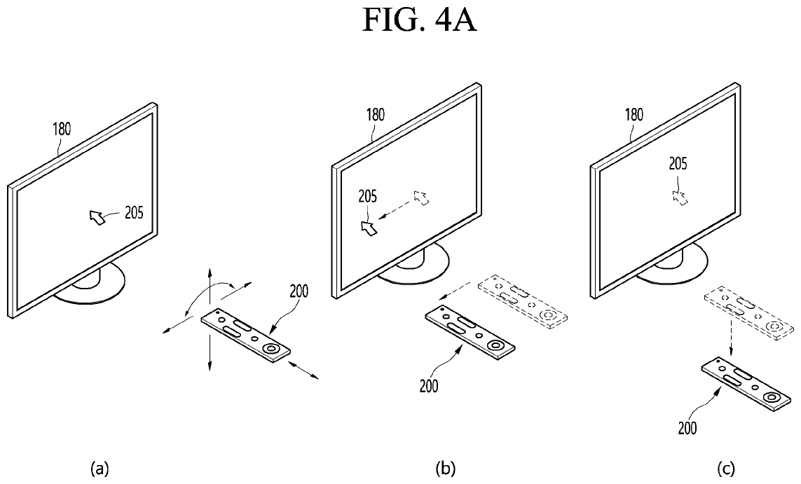

FIG. 4A is a diagram illustrating a control method for a remote control device of FIG. 2.

In (a) of FIG. 4A, it is illustrated that a pointer 205 corresponding to the remote control device 200 is displayed on the display unit 180.

The user may move or rotate the remote control device 200 up and down, left and right (FIG. 4A (b)), and forward and backward ((c) of FIG. 4A). The pointer 205 displayed on the display unit 180 of the display device may correspond to the movement of the remote control device 200. The remote control device 200 may be referred to as a spatial remote controller or a 3D pointing device, as the corresponding pointer 205 is moved and displayed according to the movement on a 3D space, as shown in the drawing.

In (b) of FIG. 4A, it is illustrated that that when the user moves the remote control device 200 to the left, the pointer 205 displayed on the display unit 180 of the display device moves to the left correspondingly.

Information on the movement of the remote control device 200 detected through a sensor of the remote control device 200 is transmitted to the display device. The display device may calculate the coordinates of the pointer 205 based on information on the movement of the remote control device 200. The display device may display the pointer 205 to correspond to the calculated coordinates.

In (c) of FIG. 4A, it is illustrated that a user moves the remote control device 200 away from the display unit 180 while pressing a specific button in the remote control device 200. Accordingly, a selected region in the display unit 180 corresponding to the pointer 205 may be zoomed in and displayed to be enlarged. Conversely, when the user moves the remote control device 200 close to the display unit 180, the selected region in the display unit 180 corresponding to the pointer 205 may be zoomed out and displayed to be reduced. On the other hand, when the remote control device 200 moves away from the display unit 180, the selected region may be zoomed out, and when the remote control device 200 moves close to the display unit 180, the selected region may be zoomed in.

Meanwhile, in a state in which a specific button in the remote control device 200 is being pressed, recognition of up, down, left, or right movements may be excluded. That is, when the remote control device 200 moves away from or close to the display unit 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

FIG. 4B is an internal block diagram of the remote control device of FIG. 2.

Referring to the drawing, the remote control device 200 may include a wireless communication unit 420, a user input unit 430, a sensor unit 440, an output unit 450, a power supply unit 460, a storage unit 470, ad a control unit 480.

The wireless communication unit 420 may transmit and receive signals to and from any one of the display devices according to the embodiments of the present disclosure described above. Among the display devices according to embodiments of the present disclosure, one display device 100 will be described as an example.

In the present embodiment, the remote control device 200 may include an RF module 421 capable of transmitting and receiving signals to and from the display device 100 according to the RF communication standard. In addition, the remote control device 200 may include an IR module 423 capable of transmitting and receiving signals to and from the display device 100 according to the IR communication standard.

In the present embodiment, the remote control device 200 transmits a signal containing information on the movement of the remote control device 200 to the display device 100 through the RF module 421.

Also, the remote control device 200 may receive a signal transmitted by the display device 100 through the RF module 421. In addition, the remote control device 200 may transmit a command regarding power on/off, channel change, volume adjustment, or the like to the display device 100 through the IR module 423 as necessary.

The user input unit 430 may include a keypad, a button, a touch pad, or a touch screen. The user may input a command related to the display device 100 to the remote control device 200 by operating the user input unit 430. When the user input unit 430 includes a hard key button, the user may input a command related to the display device 100 to the remote control device 200 through a push operation of the hard key button. When the user input unit 430 includes a touch screen, the user may input a command related to the display device 100 to the remote control device 200 by touching a soft key of the touch screen. In addition, the user input unit 430 may include various types of input means that may be operated by a user, such as a scroll key or a jog key, and the present embodiment does not limit the scope of the present disclosure.

The sensor unit 440 may include a gyro sensor 441 or an acceleration sensor 443. The gyro sensor 441 may sense information on the movement of the remote control device 200.

For example, the gyro sensor 441 may sense information on the operation of the remote control device 200 based on the x, y, and z axes. The acceleration sensor 443 may sense information on the movement speed of the remote control device 200 and the like. Meanwhile, a distance measurement sensor may be further provided, whereby a distance to the display unit 180 may be sensed.

The output unit 450 may output a video or audio signal corresponding to the operation of the user input unit 430 or a signal transmitted from the display device 100. The user may recognize whether the user input unit 430 is operated or whether the display device 100 is controlled through the output unit 450.

For example, the output unit 450 may include an LED module 451 that emits light, a vibration module 453 that generates vibration, a sound output module 455 that outputs sound, or a display module 457 that outputs a video when the user input unit 430 is operated or a signal is transmitted and received through the wireless communication unit 420.

The power supply unit 460 supplies power to the remote control device 200. The power supply unit 460 may reduce power consumption by stopping power supply when the remote control device 200 has not moved for a predetermined time. The power supply unit 460 may restart power supply when a predetermined key provided in the remote control device 200 is operated.

The storage unit 470 may store various types of programs and application data required for control or operation of the remote control device 200. When the remote control device 200 transmits and receives signals wirelessly through the display device 100 and the RF module 421, the remote control device 200 and the display device 100 transmit and receive signals through a predetermined frequency band. The control unit 480 of the remote control device 200 may store and refer to information on a frequency band capable of wirelessly transmitting and receiving signals to and from the display device 100 paired with the remote control device 200 in the storage unit 470.

The control unit 480 may control all matters related to the control of the remote control device 200. The control unit 480 may transmit a signal corresponding to a predetermined key operation of the user input unit 430 or a signal corresponding to the movement of the remote control device 200 sensed by the sensor unit 440 through the wireless communication unit 420.

The user input interface unit 150 of the display device 100 may include a wireless communication unit 411 capable of wirelessly transmitting and receiving signals to and from the remote control device 200, and a coordinate value calculating unit 415 capable of calculating coordinate values of a pointer corresponding to the operation of the remote control device 200.

The user input interface unit 150 may transmit and receive signals wirelessly to and from the remote control device 200 through the RF module 412. In addition, signals transmitted by the remote control device 200 according to the IR communication standard may be received through the IR module 413.

The coordinate value calculating unit 415 may correct a hand shake or an error based on a signal corresponding to the operation of the remote control device 200 received through the wireless communication unit 411, and calculate the coordinate values (x, y) of the pointer 205 to be displayed on the display unit 180.

The transmission signal of the remote control device 200 input to the display device 100 through the user input interface unit 150 may be transmitted to the control unit 170 of the display device 100. The control unit 170 may determine information on the operation and key operation of the remote control device 200 based on the signal transmitted by the remote control device 200, and control the display device 100 in response thereto.

As another example, the remote control device 200 may calculate pointer coordinate values corresponding to the operation and output the same to the user input interface unit 150 of the display device 100. In this case, the user input interface unit 150 of the display device 100 may transmit information on the received pointer coordinate values to the control unit 170 without a separate process of correcting a hand shake or error.

In addition, as another example, the coordinate value calculating unit 415 may be provided in the control unit 170 instead of the user input interface unit 150 unlike the drawing.

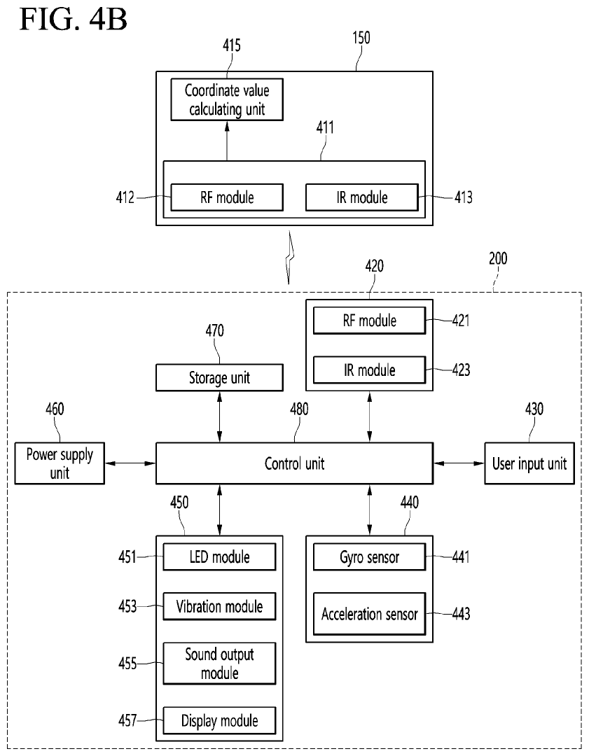

FIG. 5 is an internal block diagram of the display unit of FIG. 2.

Referring to the drawing, the display unit 180 based on an organic light emitting panel may include a panel 210, a first interface unit 230, a second interface unit 231, a timing controller 232, a gate driving unit 234, a data driving unit 236, a memory 240, a processor 270, a power supply unit 290, and the like.

The display unit 180 may receive a video signal Vd, first DC power V1, and second DC power V2, and display a predetermined video based on the video signal Vd.

Meanwhile, the first interface unit 230 in the display unit 180 may receive the video signal Vd and the first DC power V1 from the control unit 170.

Here, the first DC power supply V1 may be used for the operation of the power supply unit 290 and the timing controller 232 in the display unit 180.

Next, the second interface unit 231 may receive the second DC power V2 from the external power supply unit 190. Meanwhile, the second DC power V2 may be input to the data driving unit 236 in the display unit 180.

The timing controller 232 may output a data driving signal Sda and a gate driving signal Sga based on the video signal Vd.

For example, when the first interface unit 230 converts the input video signal Vd and outputs the converted video signal va1, the timing controller 232 may output the data driving signal Sda and the gate driving signal Sga based on the converted video signal va1.

The timing controller 232 may further receive a control signal, a vertical synchronization signal Vsync, and the like, in addition to the video signal Vd from the control unit 170.

In addition, the timing controller 232 may output the gate driving signal Sga for the operation of the gate driving unit 234 and the data driving signal Sda for operation of the data driving unit 236 based on a control signal, the vertical synchronization signal Vsync, and the like, in addition to the video signal Vd.

In this case, the data driving signal Sda may be a data driving signal for driving of RGBW subpixels when the panel 210 includes the RGBW subpixels.

Meanwhile, the timing controller 232 may further output the control signal Cs to the gate driving unit 234.

The gate driving unit 234 and the data driving unit 236 may supply a scan signal and the video signal to the panel 210 through a gate line GL and a data line DL, respectively, according to the gate driving signal Sga and the data driving signal Sda from the timing controller 232. Accordingly, the panel 210 may display a predetermined video.

Meanwhile, the panel 210 may include an organic light emitting layer and may be arranged such that a plurality of gate lines GL intersect a plurality of data lines DL in a matrix form in each pixel corresponding to the organic light emitting layer to display a video.

Meanwhile, the data driving unit 236 may output a data signal to the panel 210 based on the second DC power supply V2 from the second interface unit 231.

The power supply unit 290 may supply various levels of power to the gate driving unit 234, the data driving unit 236, the timing controller 232, and the like.

The processor 270 may perform various control of the display unit 180. For example, the gate driving unit 234, the data driving unit 236, the timing controller 232 or the like may be controlled.

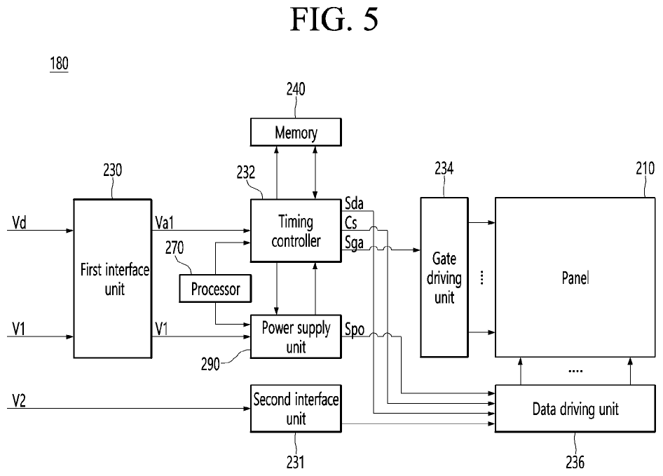

FIGS. 6A to 6B are views referred to for description of the organic light emitting panel of FIG. 5.

First, FIG. 6A is a diagram showing a pixel in the panel 210. The panel 210 may be an organic light emitting panel.

Referring to the drawing, the panel 210 may include a plurality of scan lines (Scan 1 to Scan n) and a plurality of data lines (R1, G1, B1, W1 to Rm, Gm, Bm and Wm) intersecting the scan lines.

Meanwhile, a pixel is defined at an intersection region of the scan lines and the data lines in the panel 210. In the drawing, a pixel having RGBW sub-pixels SPr1, SPg1, SPb1, and SPw1 is shown.

In FIG. 6A, although it is illustrated that the RGBW sub-pixels are provided in one pixel, RGB subpixels may be provided in one pixel. That is, it is not limited to the element arrangement method of a pixel.

FIG. 6B illustrates a circuit of a sub pixel in a pixel of the organic light emitting panel of FIG. 6A.

Referring to the drawing, an organic light emitting sub-pixel circuit CRTm may include a scan switching element SW1, a storage capacitor Cst, a driving switching element SW2, and an organic light emitting layer OLED, as active elements.

The scan switching element SW1 may be connected to a scan line at a gate terminal and may be turned on according to a scan signal Vscan, which is input. When the scan switching element SW1 is turned on, the input data signal Vdata may be transferred to the gate terminal of the driving switching element SW2 or one terminal of the storage capacitor Cst.

The storage capacitor Cst may be formed between the gate terminal and the source terminal of the driving switching element SW2, and store a predetermined difference between the level of a data signal transmitted to one terminal of the storage capacitor Cst and the level of the DC power Vdd transferred to the other terminal of the storage capacitor Cst.

For example, when the data signals have different levels according to a Pulse Amplitude Modulation (PAM) method, the level of power stored in the storage capacitor Cst may vary according to a difference in the level of the data signal Vdata.

As another example, when the data signals have different pulse widths according to the Pluse Width Modulation (PWM) method, the level of the power stored in the storage capacitor Cst may vary according to a difference in the pulse width of the data signal Vdata.

The driving switching element SW2 may be turned on according to the level of the power stored in the storage capacitor Cst. When the driving switching element SW2 is turned on, a driving current IOLED, which is proportional to the level of the stored power, flows through the organic light emitting layer OLED. Accordingly, the organic light emitting layer OLED may perform a light emitting operation.

The organic light emitting layer (OLED) includes a light emitting layer (EML) of RGBW corresponding to a subpixel, and may include at least one of a hole injection layer (HIL), a hole transport layer (HTL), an electron transport layer (ETL), and an electron injection layer (EIL) and may further include a hole blocking layer.

On the other hand, the sub pixels may emit white light in the organic light emitting layer (OLED) but, in the case of green, red, blue sub-pixels, a separate color filter is provided for realization of color. That is, in the case of green, red, and blue subpixels, green, red, and blue color filters are further provided, respectively. Meanwhile, since a white sub-pixel emits white light, a separate color filter is unnecessary.

On the other hand, although p-type MOSFETs are illustrated as the scan switching element SW1 and the driving switching element SW2 in the drawing, n-type MOSFETs or other switching elements such as JFETs, IGBTs, or SICs may be used.

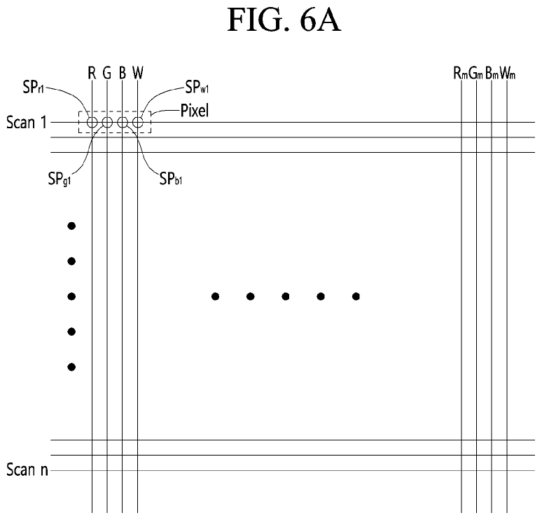

FIG. 7 is a flowchart illustrating a method of operating a display device according to an embodiment of the present disclosure.

FIG. 7 is a view illustrating an example of adjusting an application ratio of convex power control (CPC) according to the average brightness of an image frame.

Hereinafter, brightness and luminance may be used as the same concept.

In addition, the processor 270 may be included in the control unit 170 of FIG. 1.

Referring to FIG. 7, the processor 270 of the display device 100 acquires the average brightness of an image frame (S701).

The average brightness may indicate the overall brightness of the image frame.

That is, the average brightness may be an average picture level (APL).

The processor 270 may calculate the APL from the image frame of an input image signal Vd and acquire the calculated APL as the average brightness of the image frame.

The processor 270 may include an APL measurement unit for measuring the image frame. In another embodiment, the APL measurement unit may be separated from the processor 270.

The processor 270 determines whether the acquired average brightness is in a first range (S703).

In one embodiment, the first range may have a size of 80 or more and 100 or more.

When the acquired average brightness is in the first range, the processor 270 performs CPC with respect to a first CPC application region other than a first luminance maintaining region corresponding to a first ratio of the total size of the screen (S705).

The first ratio may be 75%, but this is merely an example.

The CPC algorithm may reduce the power consumption of the OLED display device through spatial luminance control of the screen.

The memory 240 of the display device 100 may store a CPC table indicating a corresponding relationship between the average brightness of the image frame and the ratio of the luminance maintaining region.

The processor 270 of the display device 100 may determine the ratio of the luminance maintaining region corresponding to the average brightness of the image frame using the CPC table stored in the memory 240.

When the ratio of the luminance maintaining region is determined, the remaining region other than the luminance maintaining region may be a CPC application region, to which the CPC algorithm will be applied.

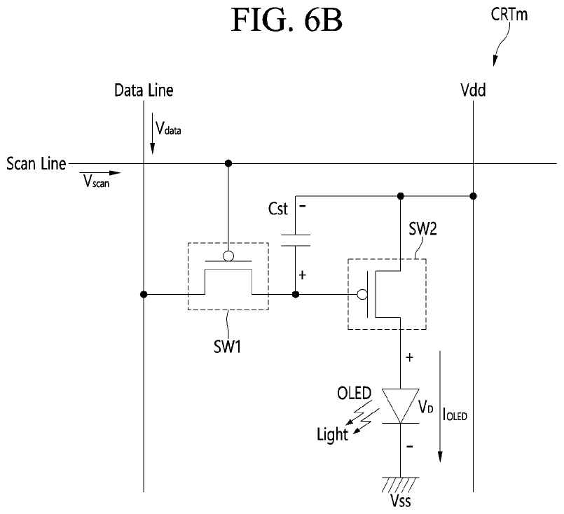

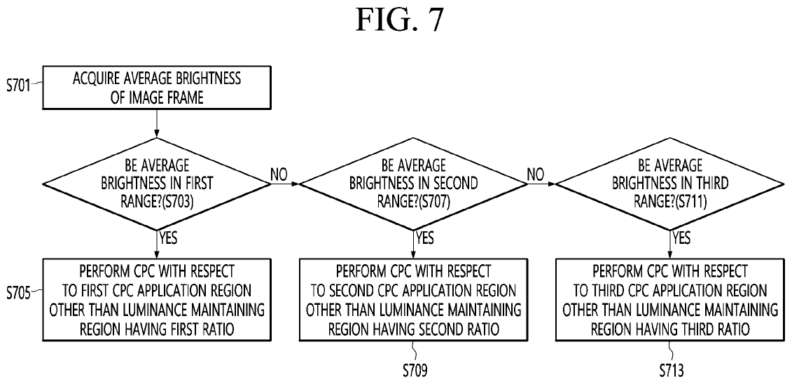

The CPC algorithm will be described with reference to FIGS. 8 and 9.

FIGS. 8 and 9 are views illustrating a CPC algorithm according to an embodiment of the present disclosure.

Since human eyes generally focus on the center of the screen, maximum luminance that a person may feel is concentrated on the center of the screen and is decreased toward an outer region.

In the CPC algorithm, using such characteristics, fixed luminance is maintained in the case of a still image and is gradually decreased from an edge in an elliptical shape in the case of a moving image.

The CPC algorithm may refer to an algorithm for spatially adjusting luminance according to a spatial gain value (or CPC gain) according to the position of the screen.

For example, on the screen 800 of FIG. 8, when the maximum luminance of the center is 100, the CPC algorithm may be an algorithm for reducing luminance such that the luminance of the edge becomes 25% of the maximum luminance.

Referring to FIG. 9, a graph 900 showing decrease in luminance in the vertical/horizontal cross-section of the screen is shown.

The graph 900 of FIG. 9 shows that the luminance of the center of the center is 100 and the luminance decrease from the center to the vertex of the screen.

FIG. 7 will be described again.

The processor 270 may change the region (the CPC application region) of the screen, to which the CPC algorithm will be applied, according to the average brightness of the image frame.

That is, the processor 270 may maintain the luminance maintaining region in which the luminance will be maintained and the CPC application region in which the CPC algorithm will be driven, according to the average brightness of the image frame.

As the average brightness of the image frame increases, the size of the luminance maintaining region may increase, and, as the average brightness of the image frame decreases, the size of the luminance maintaining region may decrease.

When the average brightness of the image frame is in the first range, the size of the luminance maintaining region may correspond to the first ratio of the total size of the screen. The first ration may be 75%.

That is, when the screen of the display panel has a size of 8K (7680×4320), the luminance maintaining region may have a size of (5760×3240) which is 75% of (7680×4320).

The processor 270 may maintain the luminance of the luminance maintaining region corresponding to the first ratio (75%) of the total size of the screen and drive the CPC algorithm with respect to the CPC application region other than the luminance maintaining region.

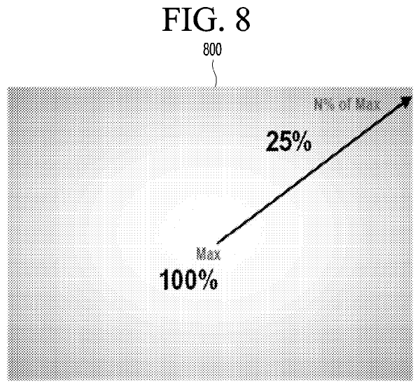

This will be described in greater detail with reference to FIG. 10.

FIG. 10 is a view illustrating a CPC algorithm driving method when the average brightness of an image frame is in a first range, according to an embodiment of the present disclosure.

In FIG. 10, it is assumed that the average brightness of a first image frame 1001 belongs to a first range.

The display device 100 may determine a first luminance maintaining region 1010 corresponding to the first range when the average brightness of the first image frame 1001 belongs to the first range.

The entire region 1000 of the screen may include the first luminance maintaining region 1010 and a first CPC application region 1030.

The first luminance maintaining region 1010 may be a region in which the luminance is maintained, when the average brightness of the first image frame 1001 is in the first range.

The first luminance maintaining region 1010 may be the central region of the screen and have an elliptical shape.

The size of the first luminance maintaining region 1010 may correspond to the first ratio (75%) of the size of the entire region 1000 of the screen.

That is, if the size of the entire region of the screen is 7680×4320, the size of the first luminance maintaining region 1010 may have a size of 5760×3240.

The first luminance maintaining region 1010 may have a flexible size of up to −7.5% based on the size of 5760×3240. In this case, the size of the first luminance maintaining region 1010 may be 5760×3240 to 5184×2916.

The processor 270 may determine the size of the first luminance maintaining region 1010 as a size of the first ratio of the entire region 1000, when the average brightness of the first image frame 1001 is in the first range.

The processor 270 may maintain the luminance of the first luminance maintaining region 1010 and drive the CPC algorithm with respect to the first CPC application region 1030.

That is, the processor 270 may gradually decrease the luminance from the edge of the screen in an elliptical shape with respect to the first CPC application region 1030.

The first CPC application region 1030 may include a top region 1031 adjacent to the top of the first luminance maintaining region 1010, a bottom region 1032 adjacent to the bottom of the first luminance maintaining region 1010, a right region 1033 adjacent to the right side of the first luminance maintaining region 1010 and a left region 1034 adjacent to the left side of the first luminance maintaining region 1010, a top right region 1035 located at the top right side of the first luminance maintaining region 1010, a top left region 1036 located at the top left side of the first luminance maintaining region 1010, a bottom left region 1037 located at the bottom left side of the first luminance maintaining region 1010 and a bottom right region 1038 located at the bottom right side of the first luminance maintaining region 1010.

The processor 270 may decrease the luminance of a plurality of pixels included in the first CPC application region 1030 while maintaining the luminance of a plurality of pixels included in the first luminance maintaining region 1010.

That is, the processor 270 may decrease the luminance of the top region 1031, the bottom region 1032, the right region 1033 and the left region 1034 by 10% of the original luminance and decrease the luminance of the top right region 1035, the top left region 1036, the bottom left region 1037 and the bottom right region 1038 by 25% of the original luminance, using the CPC algorithm.

The processor 270 may control the level of current applied to the OLED included in each pixel for luminance control of each pixel.

When the average brightness of the first image frame 1001 is in the first range, the processor 270 may maintain the luminance of the first luminance maintaining region 1010 corresponding to the first ratio of the total size of the screen and drive the CPC algorithm to decrease the luminance of the first CPC application region 1030.

Therefore, afterimages occurring on the display panel may be reduced and power consumption may be reduced.

FIG. 7 will be described again.

When the acquired average brightness is in a second range less than the first range (S707), the processor 270 performs CPC with respect to a second CPC application region other than a second luminance maintaining region corresponding to a second ratio of the total size of the screen (S709).

The second range may have a size of 60 or more and less than 80.

The second ratio is less than the first ratio. The second ratio may be 60%, but is merely an example.

When the average brightness of the image frame is in the second range, the processor 270 may determine the second luminance maintaining region corresponding to the second range.

The processor 270 may perform the CPC algorithm with respect to the entire region of the screen in consideration of the second luminance maintaining region.

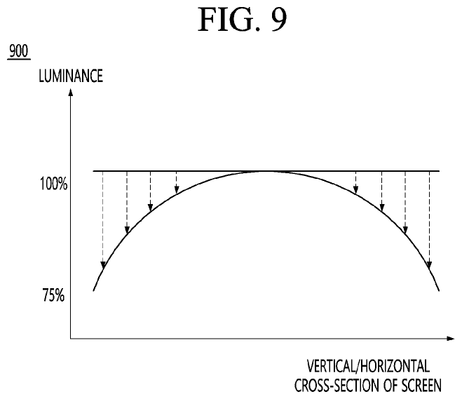

This will be described with reference to FIG. 11.

FIG. 11 is a view illustrating a CPC algorithm driving method when the average brightness of an image frame is in a second range, according to an embodiment of the present disclosure.

In FIG. 11, it is assumed that the average brightness of a second image frame 1101 belongs to the second range.

When the average brightness of the second image frame 1101 is in the second range, the display device 100 may determine the second luminance maintaining region 1100 corresponding to the second range in the entire region 1100 of the screen.

The size of the second luminance maintaining region 1100 may be less than that of the first luminance maintaining region 1010. This is because the average brightness of the second image frame 1101 is less than that of the first image frame 1001 and thus the CPC application may be further increased to reduce power consumption.

The entire region 1100 of the screen may include the second luminance maintaining region 1110 and the second CPC application region 1130.

The second luminance maintaining region 1110 may be the central region of the screen and have an elliptical shape.

The size of the second luminance maintaining region 1110 may correspond to the second ratio (60%) of the size of the entire region 1100 of the screen.

That is, when the size of the entire region of the screen is 7680×4320, the size of the second luminance maintaining region 1110 may be 4608×2592.

The second luminance maintaining region 1110 may have a flexible size from +7.5% to −7.5% based on based on 4608×2592. In this case, the size of the second luminance maintaining region 1110 may be 5184×2916 to 4032×2268.

When the average brightness of the second image frame 1101 is in the second range, the processor 270 may determine the size of the second luminance maintaining region 1110 as a size corresponding to the second ratio of the entire region 1100.

The processor 270 may maintain the luminance of the second luminance maintaining region 1110 and drive the CPC algorithm with respect to the second CPC application region 1130.

That is, the processor 270 may gradually decrease the luminance from the edge of the screen in an elliptical shape with respect to the second CPC application region 1130.

The second CPC application region 1130 may include a top region 1131 adjacent to the top of the second luminance maintaining region 1110, a bottom region 1132 adjacent to the bottom of the second luminance maintaining region 1110, a right region 1133 adjacent to the right side of the second luminance maintaining region 1110, a left region 1134 adjacent to the left side of the second luminance maintaining region 1110, a top right region 1135 located at the top right side of the second luminance maintaining region 1110, a top left region 1136 located at the top left side of the second luminance maintaining region 1110, a top left region 1137 located at the bottom left side of the second luminance maintaining region 1110 and a bottom right region 1138 located on the bottom right side of the second luminance maintaining region 1110.

The processor 270 may decrease the luminance of a plurality of pixels included in the second CPC application region 1130 while maintaining the luminance of a plurality of pixels included in the second luminance maintaining region 1110.

That is, the processor 270 may decrease the luminance of each of the top region 1131, the bottom region 1132, the right region 1133 and the left region 1134 by 15% of the original luminance and decrease the luminance of each of the top right region 1135, the top left region 1136, the bottom left region 1137 and the bottom right region 1138 by 25% of the original luminance, using the CPC algorithm.

The processor 270 may control the level of current applied to the OLED included in each pixel for luminance control of each pixel.

When the average brightness of the first image frame 1001 is in the second range, the processor 270 may maintain the luminance of the second luminance maintaining region 1110 corresponding to the second ratio of the total size of the screen and drive the CPC algorithm to decrease the luminance of the second CPC application region 1130.

Therefore, afterimages occurring on the display panel may be reduced and power consumption may be reduced.

FIG. 7 will be described again.

When the acquired average brightness is in a third range less than the second range (S711), the processor 270 performs a third CPC application region other than a third luminance maintaining region corresponding to a third ratio of the total size of the screen (S713).

The third range may have a size of 40 or more and less than 60.

The third ratio is less than the second ratio.

The third ratio may be 37.5%, but is merely an example.

When the average brightness of the image frame is in the third range, the processor 270 may determine the third luminance maintaining region corresponding to the third range.

The processor 270 may perform the CPC algorithm with respect to the entire region of the screen in consideration of the third luminance maintaining region.

This will be described with reference to FIG. 11.

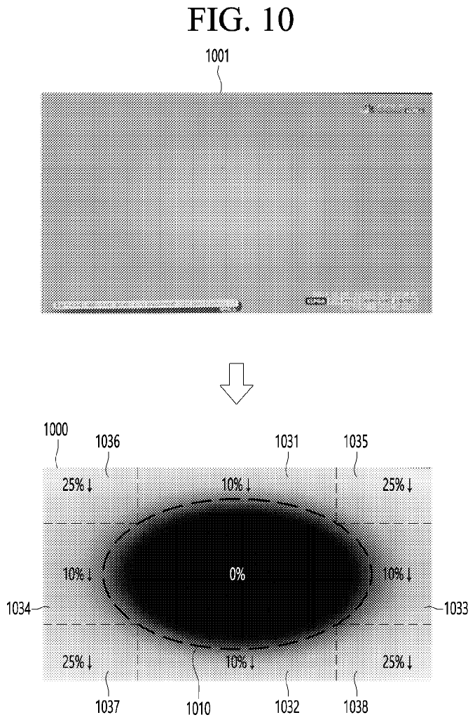

FIG. 12 is a view illustrating a CPC algorithm driving method when the average brightness of an image frame is in a third range, according to an embodiment of the present disclosure.

In FIG. 12, it is assumed that the average brightness of a third image frame 1201 belongs to the third range.

When the average brightness of the third image frame 1201 belongs to the third range, the display device 100 may determine the third luminance maintaining region 1200 corresponding to the third range in the entire region 1200 of the screen.

The size of the third luminance maintaining region 1200 may be less than that of the second luminance maintaining region 1110. This is because the average brightness of the third image frame 1201 is less than the average brightness of the second image frame 1101 and thus the CPC application may be further increased to reduce power consumption.

The entire region 1200 of the screen may include the third luminance maintaining region 1210 and a third CPC application region 1230.

The third luminance maintaining region 1210 may be the central region of the screen and have an elliptical shape.

The size of the third luminance maintaining region 1210 may correspond to a third ratio (37.5%) of the size of the entire region 1200 of the screen.

That is, when the size of the entire region 1200 of the screen is 7680×4320, the size of the third luminance maintaining region 1210 may be 2880×1620.

The third luminance maintaining region 1210 may have a flexible size of up to +7.5% based on the size of 2880×1620. In this case, the size of the third luminance maintaining region 1210 may be 2880×1620 to 3456×1944.

When the average brightness of the third image frame 1201 is in the third range, the processor 270 may determine the size of the third luminance maintaining region 1210 as a size corresponding to the third ratio of the entire region 1200.

The processor 270 may maintain the luminance of the third luminance maintaining region 1210 and derive the CPC algorithm with respect to the third CPC application region 1230.

That is, the processor 270 may gradually decrease the luminance from the edge of the screen in an elliptical shape with respect to the third CPC application region 1230.

The third CPC application region 1230 may include a top region 1231 adjacent to the top of the third luminance maintaining region 1210, a bottom region 1232 adjacent to the bottom of the third luminance maintaining region 1210, a right region 1233 adjacent to the right side of the third luminance maintaining region 1210, a left region 1234 adjacent to the left side of the third luminance maintaining region 1210, a top right region 1235 located at the top right side of the third luminance maintaining region 1210, a top left region 1236 located at the top left side of the third luminance maintaining region 1210, a bottom left region 1237 located at the bottom left side of the third luminance maintaining region 1210 and a bottom right region 1238 located at the bottom right side of the third luminance maintaining region 1210.

The processor 270 may decrease the luminance of a plurality of pixels included in the third CPC application region 1230 while maintaining the luminance of a plurality of pixels included in the third luminance maintaining region 1210.

That is, the processor 270 may decrease the luminance of each of the top region 1231, the bottom region 1232, the right region 1233, the left region 1234, the top right region 1235, the top left region 1236, the bottom left region 1237 and the bottom right region 1238 by 25% of the original luminance, using the CPC algorithm.

The processor 270 may control the level of current applied to the OLED included in each pixel for luminance control of each pixel.

When the average brightness of the first image frame 1001 is in the third range, the processor 270 may maintain the luminance of the third luminance maintaining region 1210 corresponding to the third ratio of the total size of the screen and drive the CPC algorithm to decrease the luminance of the third CPC application region 1230.

Therefore, afterimages occurring on the display panel may be reduced and power consumption may be reduced.

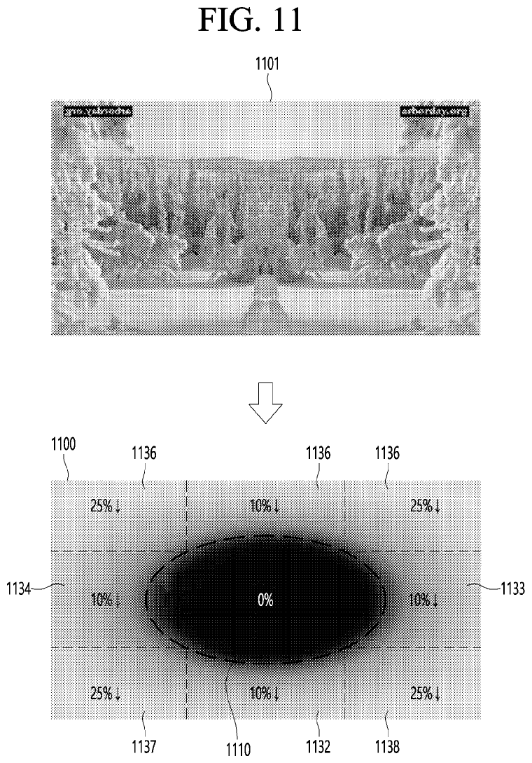

FIG. 13 is a flowchart illustrating a method of operating a display device according to another embodiment of the present disclosure.

In particular, FIG. 13 is a view illustrating a process of determining a luminance maintaining region according to a change in average brightness and performing CPC in consideration of the determined luminance maintaining region, when a scene (or image frame) change occurs.

Referring to FIG. 13, the processor 270 of the display device 100 detects a change in an image frame (S1301).

That is, the processor 270 may detect the change in the image frame based on an image signal input to the display panel.

The processor 270 may acquire the average brightness of the first image frame before changing the image frame, determine the first luminance maintaining region corresponding to the acquired average brightness, and perform the CPC algorithm with respect to the first CPC application region in consideration of the determined first luminance maintaining region.

When the change in the image frame is detected, the processor 270 acquires the average brightness of the changed image frame (S1303).

The processor 270 determines whether a range, to which the acquired average brightness belong, has been changed (S1305).

That is, the processor 270 compares a range, to which the average brightness of the first image frame belongs, with a range, to which the average brightness of the second image frame belongs, and determine whether the change in the range has occurred.

When the range, to which the average brightness belongs, is changed, the processor 270 determines a luminance maintaining region corresponding to the changed range (S1307), and performs CPC in consideration of the determined luminance maintaining region (S1309).

The processor 270 may determine the luminance maintaining region corresponding to the changed range, using the CPC table stored in the memory 240.

The processor 270 may maintain the luminance of the determined luminance maintaining region and decrease the luminance of the CPC application region other than the luminance maintaining region.

Meanwhile, when the range, to which the average brightness belongs, is not changed, the processor 270 performs CPC in consideration of the existing luminance maintaining region (S1311).

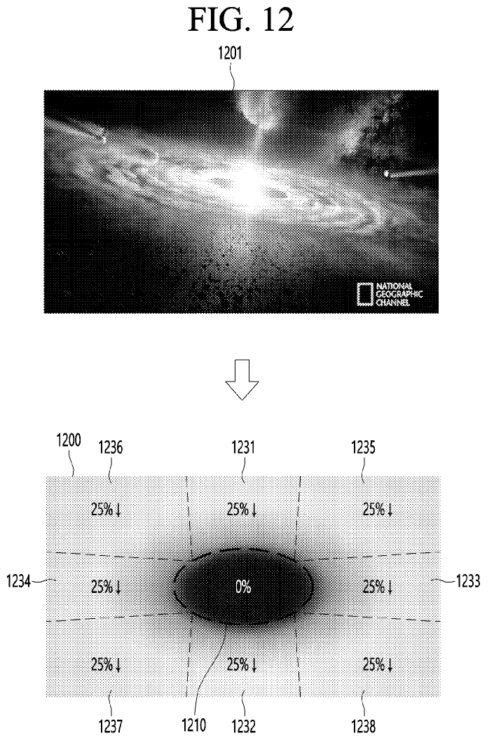

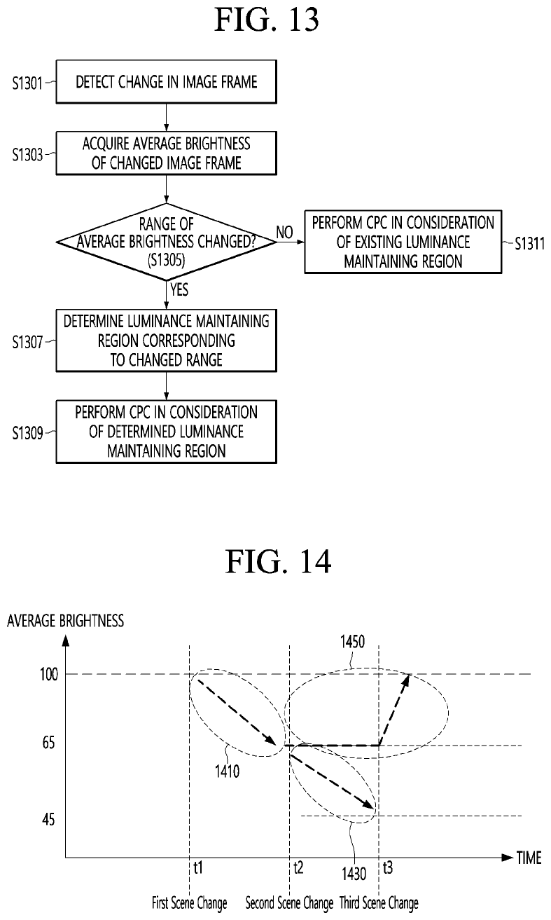

FIGS. 14 and 15 are views showing a process of determining a luminance maintaining region according to a range, to which an average brightness belongs, when a scene change occurs, according to an embodiment of the present disclosure.

FIG. 15 shows a CPC table 1500 showing a correspondence relationship between the range of the average brightness and the ratio of the luminance maintaining region.

The CPC table 1500 is stored in the memory 240 or the storage unit 140.

The range of the average brightness may be any one of a first range ((80 or more and 100 or less), a second range (60 or more and 80 or less) and a third range (40 or more and less than 60).

The ratio of the luminance maintaining region corresponding to 75% of the size of the entire region of the screen may match the first range, the ratio of the luminance maintaining region corresponding to 60% of the size of the entire region of the screen may match the second range, and the ratio of the luminance maintaining region corresponding to 35% of the entire region of the screen may match the third range.

Referring to FIG. 14, at a first time point t1, the average brightness of the image frame is changed from 100 to 65 according to the scene change (1410).

The processor 270 may confirm that the average brightness of the scene has been changed from the first range to the second range, and change the ratio of the luminance maintaining region from 75% to 60%.

The processor 270 may perform CPC in consideration of the luminance maintaining region of 60%.

In addition, at a second time point t2, it is assumed that the average brightness of the image frame is changed from 65 to 45 according to the scene change (1430).

The processor 270 may confirm that the average brightness of the scene has been changed from the second range to the third range, and change the ratio of the luminance maintaining region from 60% to 37.5%.

It is assumed that, at the second time point t2, the average brightness of the image frame is maintained at 65 according to the scene change and, at a third time point t3, the average brightness of the image frame is increased from 65 to 100 according to the scene change (1450).

The processor 270 may confirm that the average brightness of the scene has been changed from the second range to the first range, and change the ratio of the luminance maintaining region from 60% to 75%.

According to the embodiment of the present disclosure, the luminance maintaining region and the CPC application region may be flexibly adjusted according to change in image frame.

Therefore, since the luminance of the CPC application region is changed, a load on each pixel is reduced and afterimages are less generated, thereby reducing power consumption.

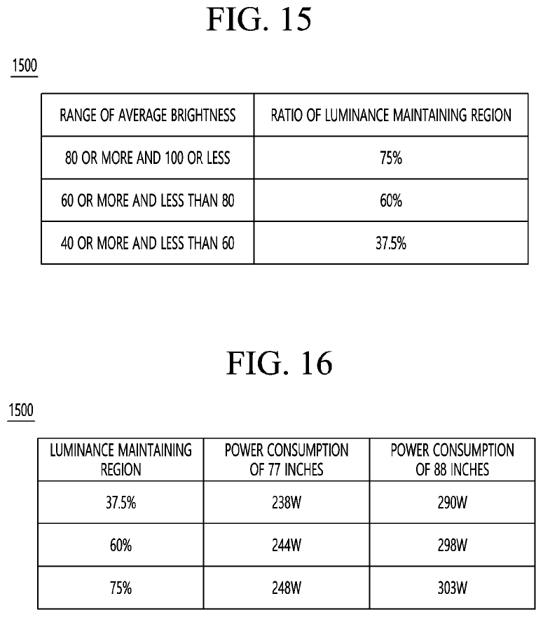

FIG. 16 is a table showing the effect of reducing actual power consumption when the embodiment of the present disclosure is applied.

FIG. 16 shows comparison in power consumption between an OLED display device having a display size of 77 inches and an OLED display device having a display size of 88 inches, if the luminance maintaining region is changed according to the average brightness of the image frame.

The power consumption of the display device having the size of 77 inches is 238 W if the luminance maintaining region 37.5%, power consumption of the display device having the size of 77 inches is 244 W if the luminance maintaining region is 60%, and the power consumption of the display device having the size of 77 inches is 248 W if the luminance maintaining region is 75%.

That is, as the ratio of the luminance maintaining region decreases, power consumption may decrease. That is, the ratio of the luminance maintaining region is changed and the CPC application region is also changed, according to the average brightness of the image frame. Therefore, power consumption may be reduced as compared to the case where the luminance maintaining region is fixed.

The power consumption of the display device having the size of 88 inches is 290 W if the luminance maintaining region 37.5%, power consumption of the display device having the size of 88 inches is 298 W if the luminance maintaining region is 60%, and the power consumption of the display device having the size of 88 inches is 303 W if the luminance maintaining region is 75%.

That is, as the ratio of the luminance maintaining region decreases, power consumption may decrease. That is, the ratio of the luminance maintaining region is changed and the CPC application region is also changed, according to the average brightness of the image frame. Therefore, power consumption may be reduced as compared to the case where the luminance maintaining region is fixed.

According to the embodiments of the present disclosure, it is possible to reduce afterimages and power consumption, by flexibly adjusting a region, in which a CPC algorithm is performed, according to the average brightness of an image frame.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like, and may be implemented in the form of a carrier wave (for example, transmission through the Internet).

The display device described above is not limited to the configuration and method of the above-described embodiments, and the above embodiments may be configured by selectively combining all or some of embodiments such that various modifications may be made.

What is claimed is:

1. An organic light-emitting diode (OLED) display device comprising:
a display panel; and
a processor configured to:
obtain an average brightness of an image frame input to the display panel, wherein the average brightness is within a range,
determine whether a luminance maintaining region is within the range, wherein the luminance maintaining region corresponds to an entire region of the display panel, and
perform a convex power control (CPC) according to a determination that the luminance maintaining region is within the range, wherein the CPC reduces power consumption of the OLED display device by reducing a luminance of an outer region of the display panel.

2. The OLED display device of claim 1, wherein determining whether the luminance maintaining region is within the range comprises:
determining whether a first luminance maintaining region corresponds to a first range based at least in part on the average brightness being in the first range, and
determining whether a second luminance maintaining region corresponds to a second range based at least in part on the average brightness being in a second range, wherein the second luminance maintaining region has a size less than the first luminance maintaining region.

3. The OLED display device of claim 2, wherein determining whether the luminance maintaining region is within the range further comprises determining whether a third luminance maintaining region corresponds to a third range based at least in part on the average brightness being in the third range, wherein the third range is less than the second range, and wherein the third luminance maintaining region has a size less than the second luminance maintaining region.

4. The OLED display device of claim 1, wherein performing the CPC comprises maintaining the luminance of the determined luminance maintaining region and decreasing the luminance of a CPC application region other than the determined luminance maintaining region according to the CPC.

5. The OLED display device of claim 1, further comprising a memory configured to store a table indicating a relationship between the range and the luminance maintaining region, and wherein the luminance maintaining region is determined using the stored table.

6. The OLED display device of claim 2, wherein the processor is further configured to:
obtain an average brightness of the image frame based on detecting a change to a second image frame;
determine whether the range has changed based at least in part on comparing the average brightness of the first image frame with an average brightness of the second image frame, wherein the average brightness of the first image frame is within the first range and the average brightness of the second image frame is within the second range; and
change the first luminance maintaining region to the second luminance maintaining region based on a determination that the range has changed, wherein the CPC is performed according to the changed second luminance maintaining region based at least in part on detecting a scene change in the first image frame to the second image frame.

7. The OLED display device of claim 1, wherein performing the CPC results in a maximum brightness in the luminance maintaining region, a minimum brightness in an outermost region of the display panel, or decreasing a brightness from the luminance maintaining region to the outermost region of the display panel.

8. A method of operating an organic light-emitting diode (OLED) display device, the method comprising:
obtaining an average brightness of an image frame input to a display panel, wherein the average brightness is within a range;
determining whether a luminance maintaining is within the range, wherein the luminance maintaining region corresponds to an entire region of the display panel; and
performing a convex power control (CPC) algorithm according to a determination that the luminance maintaining region is within the range, wherein the CPC reduces power consumption of the OLED display device by reducing a luminance of an outer region of the display panel.

9. The method of claim 8, wherein determining whether the luminance maintaining region is within the range comprises:
determining whether a first luminance maintaining region corresponds to a first range based at least in part on the average brightness being in the first range, and
determining whether a second luminance maintaining region corresponds to a second range based at least in part on the average brightness being in a second range, wherein the second luminance maintaining region has a size less than the first luminance maintaining region.

10. The method of claim 9,
wherein determining whether the luminance maintaining region is within the range further comprises determining whether a third luminance maintaining region corresponds to a third range based at least in part on the average brightness being in the third range, wherein the third range is less than the second range, and wherein the third luminance maintaining region has a size less than the second luminance maintaining region.

11. The method of claim 8, wherein performing the CPC comprises maintaining the luminance of the determined luminance maintaining region and decreasing the luminance of a CPC application region other than the determined luminance maintaining region according to the CPC.

12. The method of claim 8, further comprising storing a table indicating a relationship between the range and the luminance maintaining region, and wherein the luminance maintaining region is determined using the stored table.

13. The method of claim 9, further comprising:
obtaining an average brightness of the image frame based on detecting a change to a second image frame;
determining whether the range has changed based at least in part on comparing the average brightness of the first image frame with an average brightness of the second image frame, wherein the average brightness of the first image frame is within the first range and the average brightness of the second image frame is within the second range; and
changing the first luminance maintaining region to the second luminance maintaining region based on a determination that the range has changed, wherein the CPC is performed according to the changed second luminance maintaining region based at least in part on detecting a scene change in the first image frame to the second image frame.

14. The method of claim 8, wherein performing the CPC results in a maximum brightness in the luminance maintaining region, a minimum brightness in an outermost region of the display panel, or decreasing a brightness from the luminance maintaining region to the outermost region of the display panel.
